(19) United States
(12) Patent Application Publication
(10) Pub. No.: US 2004/0263872 A1
(43) Pub. Date: Dec. 30, 2004

(54) Photographic printing system

(75) Inventor: Hiroyuki Uchiyama, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/878,614

(22) Filed: Jun. 29, 2004

(30) Foreign Application Priority Data
Jun. 30, 2003 (JP) 2003-186448

(51) Int. Cl. G06F 3/12; H04N 1/393; G06F 13/00

(52) U.S. Cl. 358/1.2; 348/207.2; 358/1.15

(57) ABSTRACT

In a photographic printing system, image data of an image plane size (ishot L, ½x×½y) smaller than a print size (x×y) of a printer is transmitted from a portable telephone to the printer on an infrared communication basis. The transmitted image data is subjected to an expansion processing with expansion magnifications of 1.4 times to 1.8 times, and then converted to print data suitable for printing of the printer. A latent image is recorded on a recording medium in accordance with the print data. The recording medium is delivered out of the printer while it is developed. When a VGA size of image data is transmitted, the image data is directly printed out. When 1 mega size image data is transmitted, the image data is converted into image data of the number of pixels of the VGA size and then printed out.

### BACKGROUND OF THE INVENTION

1. Field of the Invention

The present invention relates to a photographic printing system comprising an image taking apparatus incorporated in for example a portable telephone wherein image data is obtained through performing a photography and the image data thus obtained is transmitted, and a printer that receives the image data transmitted from the image taking apparatus and prints out an image in accordance with the received image data.

2. Description of the Related Art

Recently, there is known a portable type of telephone, such as a portable telephone and a PHS (Personal Handyphone System), (hereinafter, which will be represented by a “portable telephone” regardless of a communication system), which is loaded with an image taking function or a camera function and a function of transmitting image data, which is obtained by the camera function, through an infrared communication and the like. To meet this situation, there is considered a printer that receives image data transmitted from the portable telephone having such functions through an infrared communication and the like and prints out an image in accordance with the received image data.

In a photographic printing system comprising an image taking apparatus incorporated in for example a portable telephone, and a printer that receives image data transmitted from the image taking apparatus and prints out an image in accordance with the received image data, a problem is the number of pixels of image data to be transmitted from the image taking apparatus to the printer.

For example, Japanese Patent Application Laid Open Gazette TokuKai 2001-94769 discloses a printer in which enlargement or reduction processing according to a paper size is performed in accordance with image data transmitted through internet and the like, while it is not concerned with an image taking apparatus and an infrared communication.

Also in the photographic printing system as mentioned above, it is preferable that image data of various numbers of pixels is transmitted and received, regardless of the number of pixels of an image to be printed out by the printer. However, even if the printer receives image data of the number of pixels, which is larger than the number of pixels of an image to be printed out by the printer, the printer may perform the reduction processing of thinning the number of pixels. In this case, the image data transmitted would not be effectively used.

For this reason, it is desired for a user to preset the optimum number of pixels of image data.

As the number of pixels to be preset, basically, it is considered to adopt the same number of pixels as the number of pixels of the image to be printed out by the printer.

However, this is an idea considering only the situation of the printing out, and when the system is considered in its entirety, it may be considered that this is not necessarily optimal.

### SUMMARY OF THE INVENTION

In view of the foregoing, it is an object of the present invention to provide a photographic printing system in which the number of pixels of image data, which is treated in an image taking apparatus, is preset to a preferable number of pixels.

To achieve the above-mentioned objects, the present invention provides a photographic printing system comprising: an image taking apparatus having an image taking section for obtaining image data through taking a photography, and a transmission section for transmitting the image data obtained by the image taking section; and a printer having a receiving section for receiving the image data transmitted from the image taking apparatus, and a printing section for printing out an image of a predetermined number of pixels in accordance with the image data received by the receiving section,

wherein the image taking apparatus is initialized in such a manner that a number of pixels of image data to be treated by the image taking apparatus is less than a number of pixels of an image to be printed out by the printing section of the printer, and

wherein the printer has a pixel number conversion section for converting the image data received by the receiving section to image data of the number of pixels suitable for printing out in the printing section.

A problem of the number of pixels is concerned with not only the situation of the print out of images, but also a viewpoint of communication times of transmission of image data.

An image obtained by the printed out of the printer is usually set up to resolution having some margin.

In view of the foregoing, according to the present invention, taking into consideration the situations in which the problems of the number of pixels occur, the image taking apparatus is initialized in such a manner that the number of pixels of image data to be treated by the image taking apparatus is less than the number of pixels of an image to be printed out by the printing section of the printer, within the range in which the associated resolution in the printed out.

Thus, this feature makes it possible to reduce the communication time and improve the quality of the photographic printing system.

In the photographic printing system according to the present invention as mentioned above, it is preferable that the image taking apparatus has a pixel number setting section for setting over again a number of pixels of the image data to be treated by the image taking apparatus from among a plurality of number of pixels including the initialized number of pixels in accordance with operation.

Thus, the initialization of the number of pixels suitable for the system makes it possible for the user who is not aware of the number of pixels to be free from the necessity of dealing with the suitable number of pixels, and for the user who is aware of the number-of pixels and alters the same to meet the demands of the user.

In the photographic printing system according to the present invention as mentioned above, it is preferable that the number of pixels to be initialized in the image taking apparatus is not less than 0.5 times and less than 1.0 times with respect to length and breadth of an image as compared with the number of pixels of an image to be printed out by the printing section of the printer.

This feature makes it possible to ensure the high-speed communication rate and limit roughness of the image plane printed out to a level in which the roughness is not conspicuous.

In the photographic printing system according to the present invention as mentioned above, it is preferable that when the pixel number conversion section receives image data of the number of pixels initialized in the image taking apparatus, the pixel number conversion section converts the image data into image data of a number of pixels of any one of magnifications in which the number of pixels is not less than 1.4 times and not above than 1.8 times with respect to length and breadth of an image.

In case of the number of pixels less than 1.4 times, there are given such impressions that for example only a part of the center of the print surface is printed out, and this is not preferable. In case of the number of pixels above than 1.8 times, roughness of the image printed out is conspicuous.

In view of the foregoing, according to the present invention, the pixel number conversion section converts the image data into image data of a number of pixels of any one of magnifications in which the number of pixels is not less than 1.4 times and not above than 1.8 times with respect to length and breadth of an image. This feature makes it possible to expand the image to the whole area of the print surface and also to print out a high quality of image less in roughness.

In the photographic printing system according to the present invention as mentioned above, it is preferable that the transmission section and the receiving section transmits and receives image data through an infrared communication, respectively.

In the photographic printing system according to the present invention as mentioned above, it is preferable that the image taking apparatus is incorporated into a portable type of telephone.

### BRIEF DESCRIPTION OF THE DRAWINGS

FIG. 1 is a perspective view showing a front side of a portable telephone incorporating therein an embodiment of an image taking apparatus constituting a photographic printing system of the present invention.

FIG. 2 is a perspective view showing a back side of a portable telephone incorporating therein an embodiment of an image taking apparatus constituting a photographic printing system of the present invention.

FIG. 3 is a block diagram of an internal structure of the portable telephone shown in FIG. 1 and FIG. 2.

FIG. 4 is a flowchart useful for understanding processing at the time of photography of the photographic printing program in form of a display mode on a display screen 211.

FIG. 5 is a flowchart useful for understanding processing at the time of printing of the photographic printing program in form of a display mode on a display screen 211.

FIG. 6 is a flowchart useful for understanding processing at the time of editing of the photographic printing program in form of a display mode on a display screen 211.

FIG. 7 is a perspective view of a printer according to an embodiment of the present invention looking from the upper.

FIG. 8 is a view showing a state that an instant film mounted on the inside of the printer is delivered out of the printer.

FIG. 9 is a perspective view of a printer according to an embodiment of the present invention looking from the back.

FIG. 10 is a perspective view of the printer, in which a front cover of the printer shown in FIG. 7 is removed to show the inside of the printer.

FIG. 11 is a typical illustration of the optical head shown in FIG. 8.

FIG. 12 is a block diagram of an internal structure of the printer.

FIG. 13 is a flowchart useful for understanding a processing procedure by the CPU of FIG. 12.

FIG. 14 is a flowchart useful for understanding a procedure for the awaiting processing of the step in FIG. 13.

FIG. 15 is a flowchart useful for understanding a procedure for the print data RAM development processing process shown in the steps of FIG. 13 and FIG. 14.

FIG. 16 is a flowchart useful for understanding a procedure for the print data correction SW processing process shown in the steps of FIG. 13 and FIG. 14.

FIG. 17 is a flowchart useful for understanding a processing procedure for the infrared communication processing process shown in the steps of FIG. 13 and FIG. 14.

FIG. 18 is a flowchart useful for understanding a processing procedure for the serial communication processing process shown in the steps of FIG. 13 and FIG. 14.

FIG. 19 is a flowchart useful for understanding a processing procedure for the print data power source off processing process and the automatic off processing process shown in the steps of FIG. 13 and FIG. 14.

FIG. 20 is a flowchart useful for understanding a processing procedure for the printing pre-processing process shown in the step of FIG. 13.

FIG. 21 is a view useful for understanding an outline of a resolution conversion in the step of FIG. 20.

FIG. 22 is another view useful for understanding an outline of a resolution conversion in the step of FIG. 20.

FIG. 23 is a flowchart useful for understanding a processing procedure for the printing processing process shown in the step of FIG. 13.

FIG. 24 is a flowchart useful for understanding a processing procedure for the instant film delivery processing process shown in the step of FIG. 13.

### DETAILED DESCRIPTION OF PREFERRED EMBODIMENTS

Embodiments of the present invention will be described with reference to the accompanying drawings.

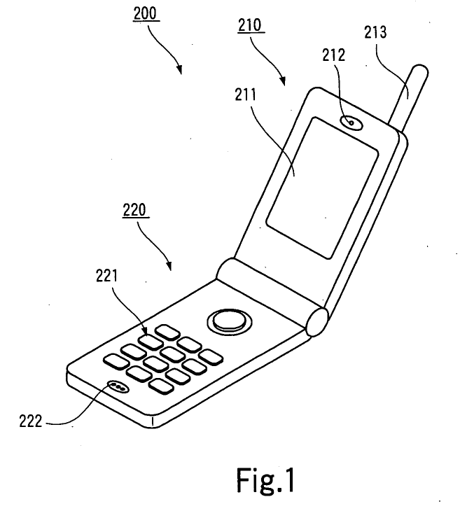

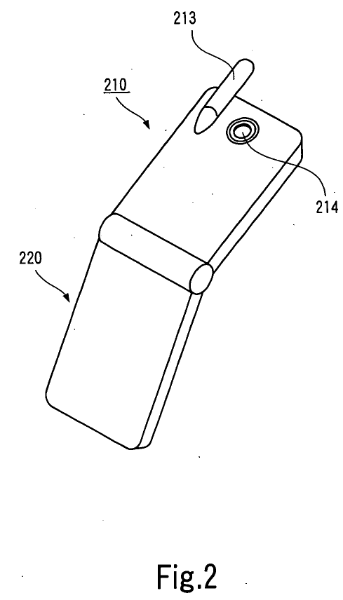

FIG. 1 is a perspective view showing a front side of a portable telephone incorporating therein an embodiment of an image taking apparatus constituting a photographic printing system of the present invention. FIG. 2 is a perspective view showing a back side of a portable telephone incorporating therein an embodiment of an image taking apparatus constituting a photographic printing system of the present invention.

A portable telephone 200 comprises an upper portion 210 and a lower portion 220, and is of a folding type.

On the upper portion 210 of the portable telephone 200, there is provided a display screen 211, an earpiece 212, an antenna 213, and a camera use image taking lens 214 which is disposed on the back. On the lower portion 220, there is provided operating key 221 and a mouthpiece 222.

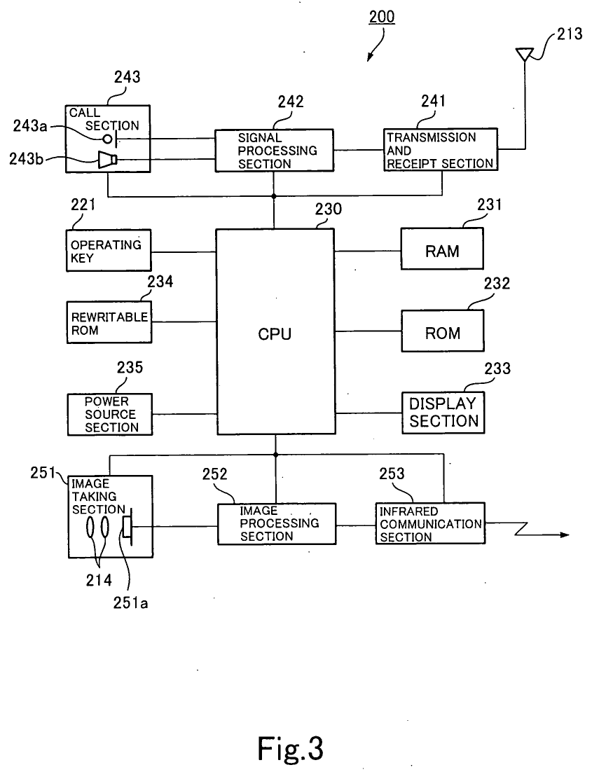

FIG. 3 is a block diagram of an internal structure of the portable telephone shown in FIG. 1 and FIG. 2.

The portable telephone 200 is so arranged that a CPU 230 controls the portable telephone. 200 in its entirety. Connected to the CPU 230 is a RAM 231, which is a volatile storage, a ROM 232, which is a non-volatile storage, a display section 233 having the display screen 211 also shown in FIG. 1, the operating key 221 also shown in FIG. 1, a rewritable ROM 234, which is a rewritable non-volatile storage, and a power source section 235.

The ROM 232 stores therein programs to be executed in the CPU 230. The rewritable ROM 234 stores therein programs down loaded by a packet communication. When the programs stored in the ROM 232 and the rewritable ROM 234 are executed in the CPU 230, operations of the respective sections of the portable telephone 200 are controlled.

While the RAM 231 is not used as a working area for programs to be executed in the CPU 230, the RAM 231 is used as a storage area for image data and set values of the number of pixels of image data to be treated in the portable telephone 200.

The display section 233 has the display screen 211 shown in FIG. 1 and displays an image on the display screen 211 in accordance with an instruction of the CPU 230.

The operating key 221 serves to transmit operations by an operator to the CPU 230. When the operating key 221 is operated, the CPU 230 controls the respective sections in accordance with the operations.

The power source section 235 is loaded with a battery (not illustrated) and supplies an electric power from the battery to the CPU 230 and the respective section of the portable telephone 200 in accordance with an instruction from the CPU 230.

The portable telephone 200 has, as structural elements for the telephone function, the antenna 213 also shown in FIG. 1 and FIG. 2, a transmission and receipt section 241, a signal processing section 242, and a call section 243. The call section 243 includes a microphone 243a disposed inside the mouthpiece 222 in FIG. 1, and a speaker 243b disposed inside the earpiece 212 in FIG. 1.

The transmission and receipt section 241 is a circuit element for transmission and receipt of a radio wave at the antenna 213. When a signal, which is obtained in the transmission and receipt section 241 by the radio wave reception through the antenna 213, is fed to the signal processing section 242 so as to be subjected to the signal processing and is outputted from the speaker 243b of the call section 243 in form of a speech sound. A speech sound picked up by the microphone 243a of the call section 243 is subjected to the signal processing in the signal processing section 242 and is transmitted via the transmission and receipt section 241 from the antenna 213 in form of radio wave.

The portable telephone 200 is provided with a packet communication function. A packet signal received via the antenna 213 and the transmission and receipt section 241 is subjected to a suitable signal processing in the signal processing section 242 and then temporarily stored in the RAM 231, or in case of the program down loaded, the program is stored in the rewritable ROM 234, so that the CPU 230 causes the packet data stored in the RAM 231 to be displayed on the display screen 211 (cf. FIG. 1) of the display section 233, or causes the program stored in the rewritable ROM 234 to be executed, in accordance with the instruction through the operating key 221.

Packet communication documents and the like, which are created through the operating key 221, are temporarily stored in the RAM 231 at the time of the creation, and are transmitted to the signal processing section 242 in accordance with the instruction through the operating key 221 so as to be subjected to a signal processing for transmission and be transmitted via the transmission and receipt section 241 and the antenna 213 in form of radio wave.

The portable telephone 200 is provided with a photographic function as an embodiment of an image taking apparatus referred to in the present invention. As elements for the photographic function, there is provided an image taking section 251, an image processing section 252, and an infrared communication section 253.

The image taking section 251 comprises the image taking lenses 214 as shown in FIG. 2 and an image taking element 251a. A subject taken in via the image taking lenses 214 is fed to the image taking element 251a to create an image signal. The image signal created in the image taking element 251a is processed by the image processing section 252 and is converted into digital image data. The digital image data is temporarily stored in the RAM 231 via the CPU 230. And the digital image data is displayed on the display screen 211 of the display section 231 or is transmitted to the exterior (a printer which will be explained later) via the infrared communication section 253, in accordance with the operation of the operating key 221. The infrared communication section 253 is provided with an infrared signal receiving function too, and receives an acknowledge signal indicative of the fact that the printer receives the transmitted image data, which is transmitted from the printer when the printer receives the transmitted image data.

Thus, according to the portable telephone, it is possible to identify whether the printer properly received the transmitted data, by means of discrimination of reception of the acknowledge signal within a predetermined time after the image data is transmitted to the printer.

Hereinafter, there will be explained mainly the photographic function and the image data transmission function in the portable telephone as shown in FIG. 1 to FIG. 3, and particularly the photographic function addressed as “ishot” (registered trademark) with which the existing portable telephone is provided.

The portable telephone is able to deal with pixel numbers 352×288×3 colors of size of image data referred to as ishot L, pixel numbers 640×480×3 colors of size of image data referred to as VGA, and pixel numbers about 1000×1000×3 colors of size of image data referred to as 1 mega. When the operating key 221 is operated to execute the photographic printing program, the ishot L is preset as image data to be treated by the portable telephone at the initial stage of the execution. Incidentally, for the portable telephone, it is possible also to utilize image data of the size of ishot S that is smaller than the ishot L in the number of pixels. However, the image data of the size of ishot S is image data of the size utilized for the packet communication and the like, and this size is too small in the number of printing outputs. Thus, according to the photographic printing program, which will be described hereinafter, it is impossible to utilize the image data of the size of ishot S. The photographic printing program is down loaded by the packet communication and is stored in the rewritable ROM 234.

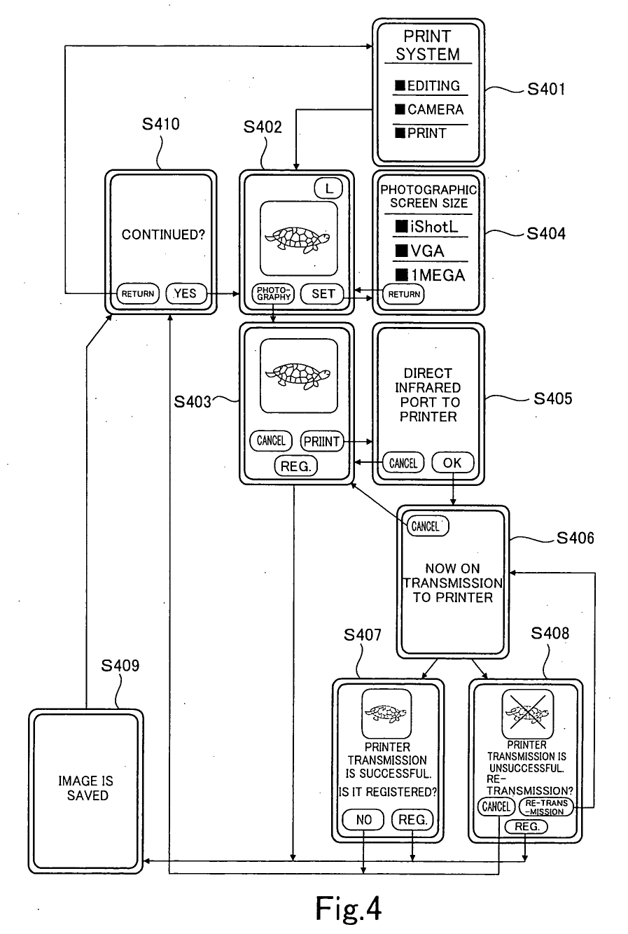

FIG. 4 is a flowchart useful for understanding processing at the time of photography of the photographic printing program in form of a display mode on a display screen 211.

When the processing at the time of photography of the photographic printing program advances, the display screen changes over to the different display mode, and the processing progresses.

When the photographic printing program starts, first, in step S401, the display screen 211 is displayed. In the display screen 211 of the step S401, items “editing”, “camera” and “print” are displayed below the title “print system”. When any one of those items “editing”, “camera” and “print” is selected, the associated processing is executed.

First, when the item “camera” of the items “editing”, “camera” and “print” is selected in accordance with the operation of the operating key 221, the photographic processing of the photographic printing program is executed. When the photographic processing is executed, the display screen of the step S401 changes over to the display screen of step S402. On the display screen of the step S402, there are displayed a through image serving as a finder, and two optional items “photography” and “set” below the through image. When the item “photography” is selected in accordance with the operation of the operating key 221, the display screen of the step S402 changes over to the display screen of step S403. When the item “set” is selected in accordance with the operation of the operating key 221, the display screen of the step S.402 changes over to the display screen of step S404. The processing section for the set corresponds to the pixel number setting section referred to in the present invention.

On the display screen of the step S404, there are displayed three items “ishot”, “VGA” and “1 mega” below the title “photographic screen”. Further, there is displayed a size for photograph, which is selected from among the pixel numbers 352×288×3 colors of size of image data referred to as ishot L, the pixel numbers 640×480×3 colors of size of image data referred to as VGA, and the pixel numbers about 1000×1000×3 colors of size of image data referred to as 1 mega, which are able to be dealt with by the portable telephone, as mentioned above. When the “set” is not selected in the step S402, the photography is performed in the preset ishot L.

In the step S402, when the “photography” is selected, the display screen changes over to the display screen of the step S403. On the display screen of the step S403, there are displayed a photographed image and selection items of “cancel”, “print” and “registration” below the photographed image. When the item “print” is selected on the display screen of the step S403, the display screen of the step S403 changes over to the display screen of the step S405. When the item “registration” is selected on the display screen of the step S403, the display screen of the step S403 changes over to the display screen of step S409. On the display screen of step S409, there is displayed a message “an image is saved”, and after the lapse of a predetermined time, the display screen of step S409 changes over to the display screen of step S410. On the display screen of step S410, there are displayed the selection items “return” and “yes” below the message “continued?”. When the item “yes” is selected on the display screen of step S410 in accordance with the operation of the operating key 221, the display screen of step S410 changes over the display screen of step S402 on which the through image of the subject is displayed. When the item “return” is selected on the display screen of step S410, the display screen of step S410 changes over to the display screen of step S401.

On the display screen of step S403, when the item “print” is selected, the display screen of step S403 changes over to the display screen of step S405 on which there are displayed selection items “cancel” and “OK” below a message “direct the infrared port to the printer”.

When the infrared port of the portable telephone is directed to the printer in accordance with the instruction of the display screen of the step S405 and the item “OK” is selected in accordance with the operation of the operating key 221, transfer of the image is initiated. Here, first, when image data is communicated between the portable telephone 200 and the printer, negotiations of the necessary communication conditions are carried out. When the negotiations are concluded between the portable telephone 200 and the printer, the transfer of the image data is initiated, and the display screen of the step S405 changes over to the display screen of the step S406, on which the massage “now on transmission to printer”. In this manner, the image data is transferred. And after the lapse of a predetermined time, when the transfer of the image data is completed, the display screen of the step S406 changes over to the display screen of the step S407, on which there are displayed a message “printer transmission is successful. Is it registered?” below the transferred image, together with the transferred image. Below the message, there are displayed selection items “no” and “reg.”. When the item “reg.” is selected, the display screen of the step S407 changes over to the display screen of step S409, and when the item “no” is selected, the display screen of the step S407 changes over to the display screen of step S410.

When the display screen of the step S406 is displayed, if a direction of the portable telephone is out of the printer, it happens that the transfer of image data is unsuccessful. In this case, there is displayed a message “transmission is unsuccessful” below the transmitted image, in the event that the acknowledge signal is not received within a predetermined time.

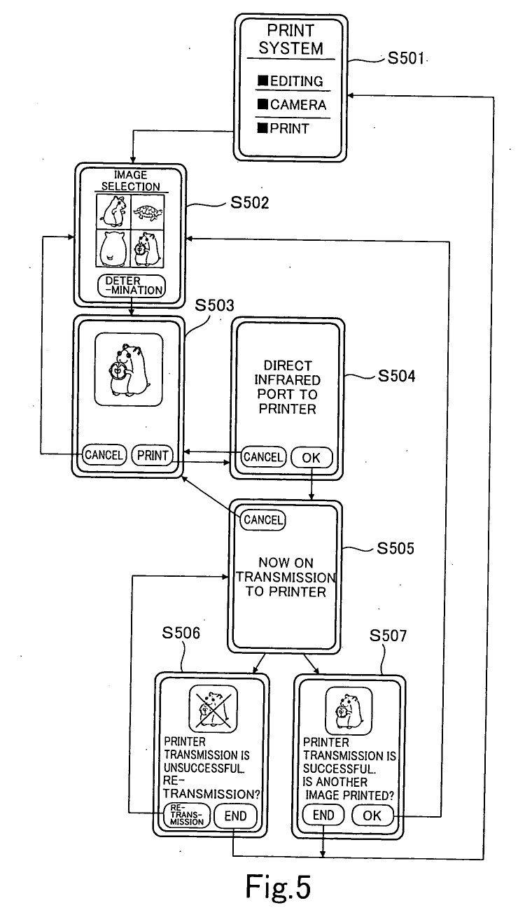

FIG. 5 is a flowchart useful for understanding processing at the time of printing of the photographic printing program in form of a display mode on a display screen 211.

When the item “print” is selected from among the items of the display screen of step S501 that is similar to the display screen of the step S401 in FIG. 4, the print processing of the photographic printing program is executed. When the print processing is executed, the display screen of step S501 changes over to a display screen of step S502 in which photographed images are displayed on a multi-screen. Here, four thumbnail images are displayed on the multi-screen. When any one is selected from among the four thumbnail images in accordance with the operation of the operating key 221, and a determination item is selected below the multi-screen, the display screen of step S502 changes over to a display screen of step S503 in which there are displayed the selected photographed image and selection items “cancel” and “print” below the photographed image.

When the item “cancel” is selected in the step S503, the process returns to the display screen of the step S502, the selection of the image is made over again. When the item “print” is selected on the display screen of the step S503, the display screen of the step S503 changes over to a display screen of the step S504. On the display screen of the step S504, there are displayed a message “direct infrared port to printer”, and selection items “cancel” and “OK” below the message.

When the infrared port of the portable telephone 200 is directed to the printer in accordance with the instruction of the display screen and the item “OK” is selected, the transfer of the image data is initiated. In this manner, when the transfer of the image data is initiated, the display screen of the step S504 changes over to the display screen of step S505 in which a message “now on transmission to printer”. When the transfer to the printer is carried out for a predetermined time and the transfer of image data is completed, the display screen of the step S505 changes over to the display screen of step S507 in which there are displayed a transferred image and a massage “printer transmission is successful. Is another image printed?” below the transferred image. And below the message, there are displayed selection items “end” and “OK” below the message. When the item “OK” is selected, the display screen of the step S507 changes over to the display screen of the step S502. When the item “end” is selected, the display screen of the step S507 changes over to the display screen of the step S501.

When the display screen of the step S506 is displayed and the portable telephone does not receive the acknowledge signal from the printer within a predetermined time during a transmission of the image data, there are displayed a transmitted image and a message “printer transmission is unsuccessful. re-transmission?” below the transmitted image. And below the message, there are displayed selection items “end” and “re-transmission?”. At that time, in order to identify the image unsuccessful in transmission, there is provided such a display that a mark “x” is applied to the transmitted image on the display screen, or alternatively that an incomplete image is displayed on the display screen.

When the item “re-transmission” is selected from among the items of the display screen of the display screen of the step S506, the display screen of the step S506 changes over to the display screen of the step S505. When the item “end” is selected from among the items of the display screen of the display screen of the step S506, the display screen of the step S506 changes over to the display screen of the step S501. The above-mentioned matter is the processing concerning the print of the photographic printing program.

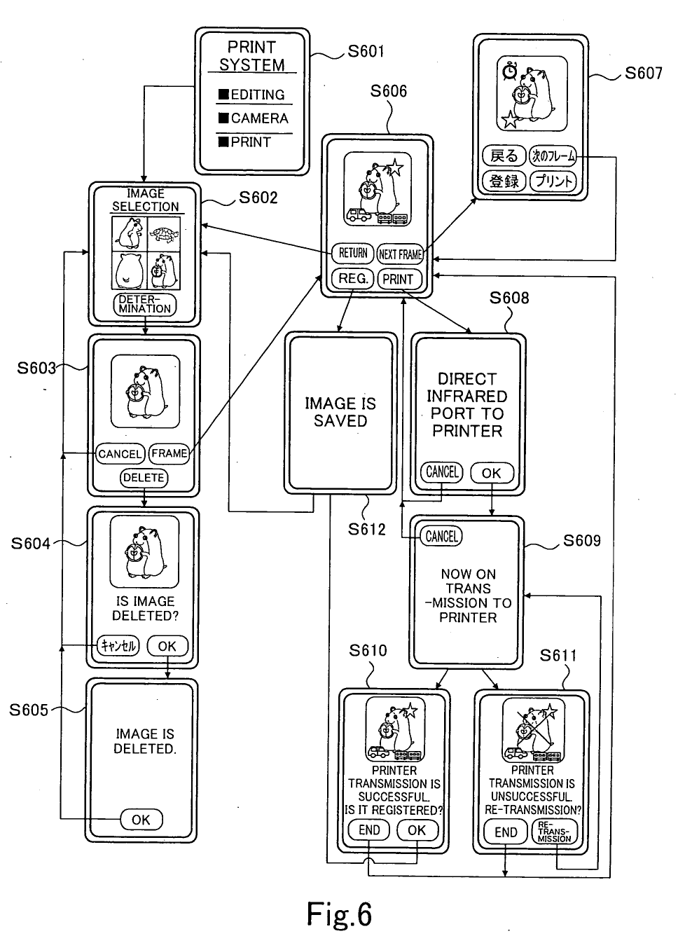

The photographic printing program is also concerned with the editing processing function, and thus there will be explained the editing processing referring to FIG. 6.

FIG. 6 is a flowchart useful for understanding processing at the time of editing of the photographic printing program in form of a display mode on a display screen 211.

In the processing at the time-of editing of the photographic printing program, there are performed erasing of the photographed image recorded on a rewritable memory and frame synthesis to the image.

When the item “editing” is selected in step S601, the editing processing of the photographic printing program is executed. In a similar fashion to the step in FIG. 5, in step S602, photographed images are displayed on a multi-screen, and below the multi-screen, there is displayed an item “determination”. When any one of the photographed images on the multi-screen is selected in accordance with the operation of the operating key 221, and the item “determination” is selected, the display screen of the step S602 changes over to a display screen of step S603 in which there are displayed the selected image and selection items “cancel”, “frame” and “cancel” below the selected image.

In the step S603, when the item “cancel” is selected, the display screen of the step S603 changes over to a display screen of step S604. In the step S604, below the selected image, there are displayed a message “is image deleted?”, and items “cancel” and “OK”. When the item “OK” is selected, there is performed deletion of image data representative of the photographed image stored in the rewritable ROM, and the display screen of the step S604 changes over to a display screen of step S605. In the step S605, there are displayed a message “image is deleted” and an item “OK” below the message. When the item “OK” is selected, the display screen of the step S605 changes over to the display screen of the step S602. In the display screens of the step S603 and the step S604, when the item “cancel” is selected, the display screens change over to the display screen of the step S602.

The above-mentioned matters are processing as to the deletion of image data representative of the photographed image.

Next, there will be explained processing for the frame synthesis.

In the display screen of the step S603, when the item “frame” is selected, the display screen of the step S603 changes over to a display screen of step S606 in which an image that is subjected to the frame synthesis is displayed, and below the image subjected to the frame synthesis, there are displayed items “return”, “next frame”, “registration”, and “print”. When the item “next frame” is selected, the frame in the display screen of the step S606 changes over to another frame, so that an image, in which another frame is synthesized as shown in the display screen of step S607, is displayed. Also below the image in which another frame is synthesized, in a similar fashion to that of the display screen of the step S606, there are displayed items “return”, “next frame”, “registration”, and print”. When the item “next frame” is selected, the display screen of the step S607 returns to the display screen of the step S606.

When the item “print” in the display screen of the step S606 is selected, the display screen of the step S606 changes over to a display screen of step S608 in which there are displayed a message “direct infrared port to printer” and selection items “cancel” and “OK” below the message.

When the infrared port of the portable telephone is directed to the printer in accordance with the instruction on the display screen and the item “OK” is selected, a transmission of image data is initiated. When the transmission of image data is initiated, the display screen of the step S608 changes over to a display screen of step S609 in which there is displayed a message “now on transmission to printer”. When the transfer of image data to the printer is performed for a predetermined time and is completed, the display screen of the step S609 changes over to a display screen of step S610. On the display screen of step S610, there are displayed a transferred image and a message “printer transmission is successful. Is it registered?” below the transferred image. Further below the message there are displayed items “end” and “OK”. When the item “OK” is selected, the display screen of the step S610 changes over to a display screen of step S612. When the item “end” is selected, the display screen of the step S610 changes over to the display screen of step S606.

In the event that the display screen of the step S609, and the portable telephone does not receive the acknowledge signal from the printer within a predetermined time while the transmission of the image data is carried out, the display screen of the step S609 changes over to a display screen of step S611, in which there are displayed a transferred image, a message “printer transmission is unsuccessful. Re-transmission?” below the transferred image, and selection items “end” and “re-transmission” below the message. At that time, in order to identify the image unsuccessful in transmission, there is provided such a display that a mark “x” is applied to the transmitted image on the display screen, or alternatively that an incomplete image is displayed on the display screen.

When the item “REG.” is selected on the display screen of the step S606, an image, which is subjected to the frame synthesis, is stored in the rewritable ROM, and the display screen of the step S606 changes over to the display screen of the step S612. In the display screen of the step S612, there is displayed a message “image is saved”, and after the lapse of a predetermined time, the display screen of the step S612 changes over to the display screen of the step S602.

The above-mentioned description is concerned with the printing processing as to the synthesis of the frame.

Next, there will be explained a structure of a printer that performs printing when the printer receives image data transferred from a portable telephone in accordance with a photographic printing program. The photographic printing system comprises the portable telephone and the printer.

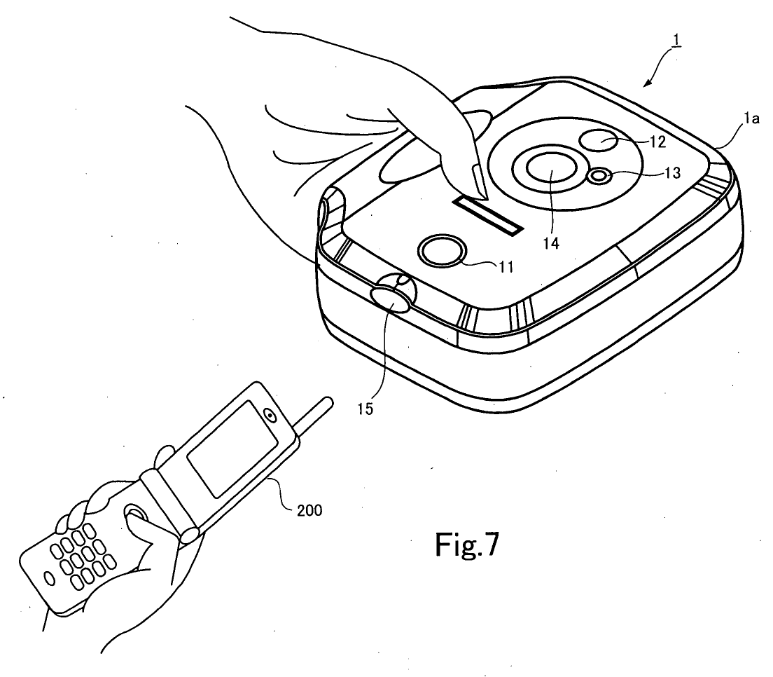

FIG. 7 is a perspective view of a printer according to an embodiment of the present invention looking from the upper.

A printer of the present invention performs recording an image on an instant film sheet in accordance with image data representative of an image photographed through the portable telephone as shown in FIG. 1, when the printer receives the image data on a radio transmission basis using the infrared communication. According to the printer, it is possible to perform recording of the image on another instant film sheet through a simple operation by the operating key 221, without re-transmission of the image data from the portable telephone.

Next, there will be explained the structure of the printer according to the present embodiment referring to FIG. 7.

A printer 1 is a portable and has a structure of such a degree of compactness and lightness that an operator can perform a recording operation for an image through having both the portable telephone 200 and the printer 1 by one's hands. An instant film pack is mounted inside a cover member la of the printer 1, so that recording for images is performed on laminated instant film sheets inside the instant film pack one by one.

On the top of the cover member 1a of the printer 1, there are provided a power source switch SW 11 for instructing turn-on and turn-off of a power source of the printer 1, a print switch SW 12, and a print data correction switch SW 13. At the center of the top of the cover member 1a of the printer 1, there is provided an LCD panel 14 that indicates the number of remaining instant film sheets and contents of the print data correction switch SW 13. Further, there is provided a photo-electric element 15 for receiving image data transmitted from the portable telephone through the infrared communication. The photo-electric element 15 is disposed at an edge portion of the cover member 1a, which is a position that is easy to direct the portable telephone to the printer. While FIG. 1 fails to illustrate, the printer 1 has a communication port for the USB communication.

The print SW 12 is operated in case of re-recording of the same image as that after recording of an image on a recording medium is completed. The print data correction switch SW 13 is for controlling dark or light of an image to be recorded on a recording medium. When the print data correction switch SW 13 is switched to a “dark” side, an image, in which tone of the image according to the image data in its entirety is slightly dark, is recorded on an instant film sheet. When the print data correction switch SW 13 is switched to a “light” side, an image, in which tone of the image according to the image data in its entirety is slightly light, is recorded on an instant film sheet. When the print SW 12 is operated after the print data correction switch SW 13 is operated, it is possible to obtain photographs which are the same as one another in composition, but different from one another in interest.

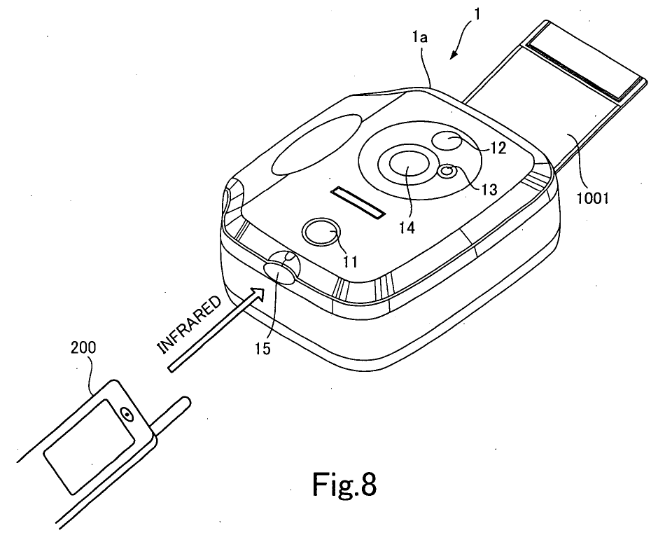

FIG. 8 is a view showing a state that an instant film mounted on the inside of the printer is delivered out of the printer.

FIG. 8 shows a state that after an optical head, which will be described later, is used to perform a recording of a latent image on an instant film sheet 1001, the latent image on the instant film sheet 1001 is developed and the instant film sheet 1001 is delivered from a delivery slot of the printer.

According to this printer, when the printer receives image data from the exterior through the infrared communication and the USB communication, a latent image based on the received image data is recorded on an instant film 1001 by the exposure, and as shown in FIG. 8, the latent image recorded on the instant film 1001 is developed and the instant film 1001 is delivered out of the printer 1. Thereafter, also when the print switch SW 12 is operated, re-recording for the same image is carried out on another instant film, and as shown in FIG. 8, the instant film 1001 is delivered.

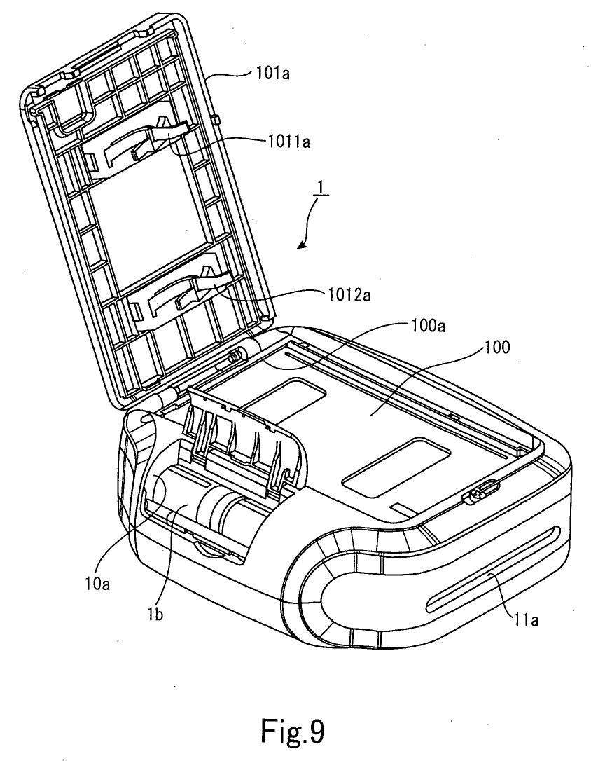

FIG. 9 is a perspective view of a printer according to an embodiment of the present invention looking from the back.

At the under side of the printer 1, there is provided a film door 101a for mounting a film pack 100. The film door 101a is opened to mount the film pack 100 on a film-mounting chamber 100a. The film-mounting chamber 10a corresponds to the medium-mounting chamber referred to in the present invention.

A battery-mounting chamber 10a for mounting a battery 1b as a power source for the printer 1 is provided in the vicinity of the film-mounting chamber 100a. The battery-mounting chamber 10a also has a door. The door is opened to mount the battery 1b.

Inside the film door 101a, there are provided two spring members 1011a and 1012a. The spring members 1011a and 1012a push the instant film sheets laminated in the instant film pack 100 to the upper side of the printer 1. This structure causes the instant film sheet 1001, which is located at the top, of the instant film sheets in the instant film pack 100, to be pushed to a position close to a delivery slot 11a, so that a large number of points, which is focused on the instant film sheet pushed to the position, is recorded through an exposure.

Next, there will be explained an internal structure of the printer 1.

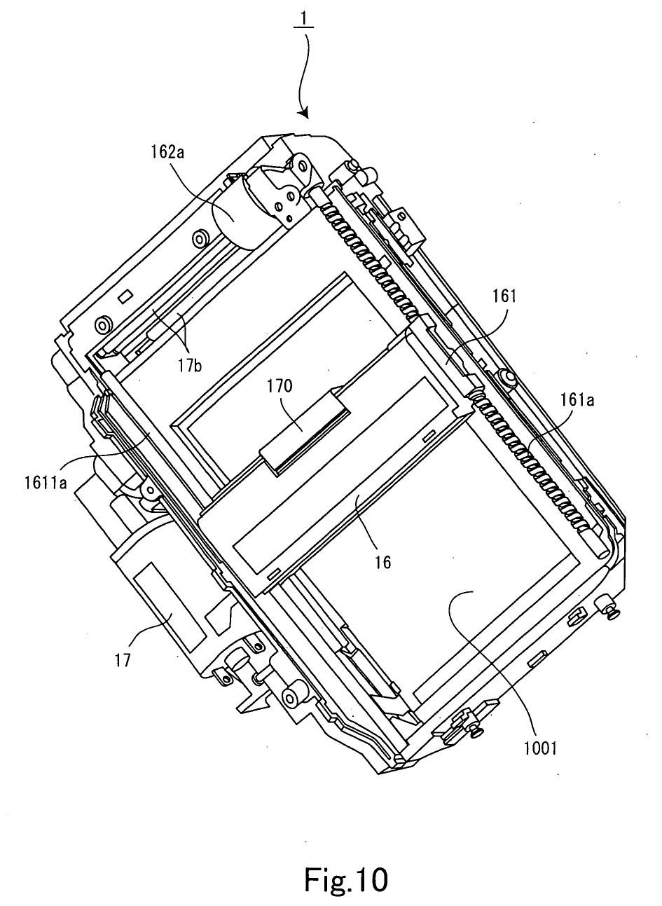

FIG. 10 is a perspective view of the printer, in which a front cover of the printer 1 shown in FIG. 7 is removed to show the inside of the printer.

As shown in FIG. 10, there is disposed an optical head section 16 at the position opposite to the instant film sheet 1001, which is located at the top, of the instant film sheets laminated in the instant film pack mounted inside the printer 1.

At an edge portion of the optical head section 16, there is provided a rack member 161, which is elastically engaged with a screw of a lead screw 161a supported by the cover member 1a on a spiral basis. At the opposite side to the side wherein the rack member 161 of the optical head section 16 is provided, there is provided a guide rod 1611a with which the edge portion of the optical head section 16 is engaged. While the guide rod 1611a guides the optical head section 16, the optical head section 16 is moved by engagement of the lead screw 161a with the rack member 161.

As shown in FIG. 10, the optical head section 16 is connected with a flat cable 170 via which a control signal according to image data is fed from a printing control section that will be described later. The control signal controls shutter speeds of shutters of a liquid crystal shutter array (that will be described later) of the optical head section 16. The shutter speeds of shutters of the liquid crystal array are controlled in accordance with image data, and the instant film is irradiated with lights that are associated with RGB, respectively, so that a latent image, which consists of 480 pieces of light spots (dots) in a width direction of the instant film, is recorded. Hereinafter, the width direction of the instant film, that is, a direction in which the shutters are arranged on a one-dimensional basis, is referred to as a main scanning direction. Accordingly, when the shutters are electrically scanned in the main scanning direction, a line of 480 pieces of light spots is recorded on the instant film 1001. When the electric scanning of the optical head section 16 causes the light spots consisting of 480 dots to be recorded in the main scanning direction of the instant film 1001, a stepping motor 162a rotates in accordance with the control signal from a printing control section that will be described later, so that the lead screw 161a rotates by a predetermined angle. Then, the optical head section 16 sequentially records light spots 480 dots by 480 dots in a direction intersecting to the main scanning direction. Hereinafter, the direction intersecting to the main scanning direction is referred to as a sub-scanning direction. In the sub-scanning direction, 640 lines of light spots are recorded on the instant film in its entirety, where the corresponding 480 dots of light spots, which are recorded through once main scanning of the optical head section 16, are established as one line.

When a latent image representative of an image is recorded with assembly of the light spots, a development roller 17b rolls up the instant film sheet 1001 so that developer in the instant film is developed in the instant film sheet 1001 in its entirety, and the latent image is developed and delivered out of the printer. The instant film sheet 1001 is a self-developing processing type of photosensitive material. When the developing roller 17b (see FIG. 10) rolls up the instant film sheet 1001, the developer filled in the instant film is uniformly developed in the instant film sheet 1001 in its entirety so that a latent image on the film sheet is developed. In this manner, while the optical head is moved on the instant film in a predetermined sub-scanning direction, when light spots, which are arranged in a main scanning direction intersecting to the sub-scanning direction, are irradiated in accordance with image data, a latent image is recorded on the instant film.

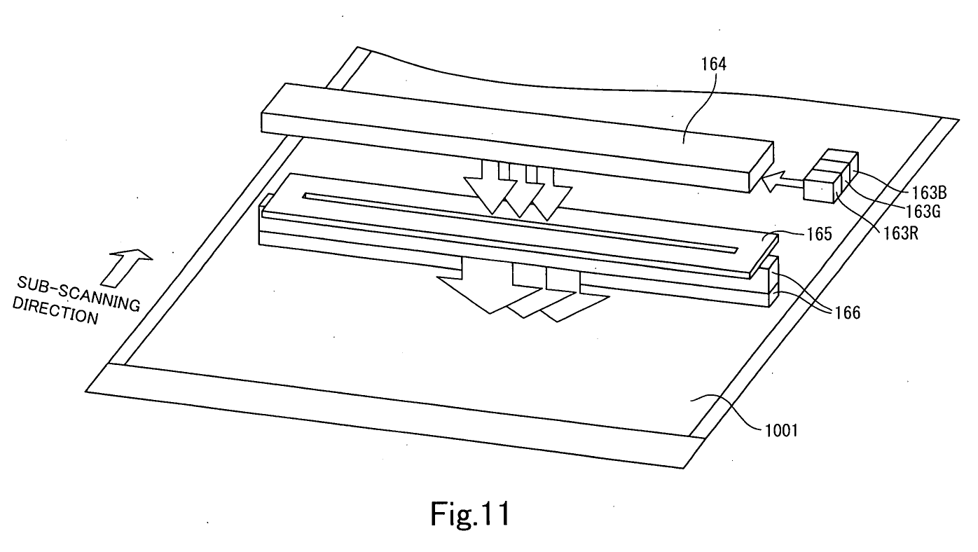

Next, there will be explained a structure of the optical head 16 referring to FIG. 11.

FIG. 11 is a typical illustration of the optical head shown in FIG. 10.

FIG. 11 shows an arrangement sequence of light-emitting devices 163R, 163G and 163B arranged on an edge portion of a light introducing plate 164, and a travelling direction of lights of R, G and B, which are projected onto the instant film in form of the light spot, with arrows typically.

As shown in FIG. 11, the optical head 16 comprises the light-emitting devices 163R, 163G and 163B for R, G and B, which are three primary colors of light, the light introducing plate 164, the liquid crystal shutter array 165, and a lens 166.

As will be seen from FIG. 11, the light-emitting devices 163R, 163G and 163B are disposed on an edge portion of the light introducing plate 164. Lights emitted from the light-emitting devices 163R, 163G and 163B are introduced via the light introducing plate 164 to the instant film sheet 1001. The light introducing plate 164 alters courses of lights introduced to the instant film sheet 1001 side, so that the lights are projected onto the instant film sheet 1001. The thus projected lights reach the instant film sheet 1001 via the shutters of the liquid crystal shutter array 165 and Selfoc Lenses (registered trademark) 166. In this manner, lights, which are controlled in light quantity by the shutters of the liquid crystal shutter array 165, are converged on the instant film by Selfoc Lenses (registered trademark) 166 so as to form light spots, and the thus focused light spots are recorded on the instant film. Here, the liquid crystal shutter array 165 consisting of 480 elements is used to control shutter speeds of the shutters in accordance with image data, so that 480 pieces of light spots having gradation according to the image data are recorded on the instant film. This is recorded by the corresponding 640 lines in the sub-scanning direction, so that 480×640 (VGA size) of light spots are recorded on the instant film in form of a latent image. This latent image represents a color image in which lights of three colors of R, G and B are recorded on the same light spot by Selfoc Lenses (registered trademark) 166.

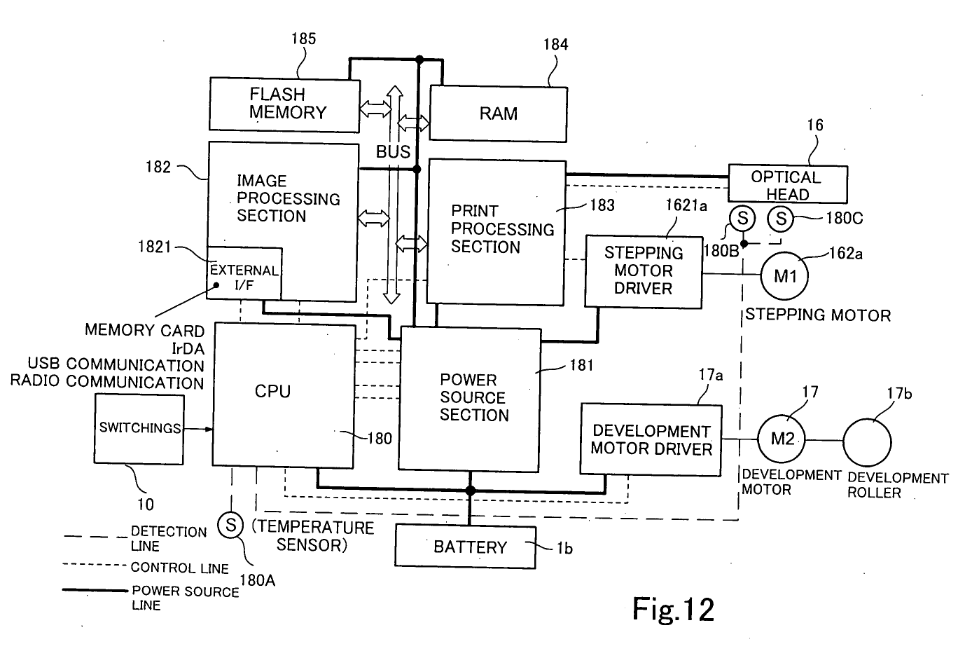

FIG. 12 is a block diagram showing a structure for driving the optical head 16, the development roller 17b, and the stepping motor 162a.

As shown in FIG. 12, CPU 180 controls an operation of the printer 1.

In order to control the printer 1 even if the power source of the printer 1 is broken, an electric power is directly supplied from a battery 1b to the CPU 180. While the battery 1b directly supplies further to a power source section 181 and a development motor driver 17a, the power source section 181 and the development motor driver 17a do not operate unless they receive instructions from the CPU 180. Thus, no electric power is consumed for the power source section 181 and the development motor driver 17a. A power supply to an image processing section 182, a stepping motor driver 1621a, a print processing section 183, a RAM 184 that is a volatile storage, a FLASH memory 185 that is a non-volatile storage, and an external I/F 1821 of the image processing section 182, is performed via the power source section 181. The CPU 180 controls the power source section 181. And no power is supplied to the respective sections unless the CPU 180 instructs. In FIG. 12, power source lines of directly supplying electric power from the battery, and power source lines of supplying electric power from the battery via the power source section are depicted with thick lines, and control lines and detection lines are depicted with dotted lines.

In this manner, a control of turn-on and turn-off of the output of the power source section 181 by the CPU 180 makes it possible to suppress a power dissipation and thereby contributing to elongating a life time of the battery 1b. Thus, as mentioned above, when the battery 1b is mounted on the battery-mounting chamber 10a of the printer 1, the printer 1 is available for a long time with the battery 1b.

Various sorts of switch 10, such as ones shown in FIG. 7, are connected to the CPU 180. The CPU 180 controls the respective sections shown in FIG. 6 in accordance with operations of the various sorts of switch 10. After the power source switch 11 of the various sorts of switch 10 is turned on, when the printer 1 receives image data from the exterior through the infrared communication or the USB communication, an image recording is performed under the control of the CPU 180 even if the various sorts of switch 10 is not operated.

The CPU 180 receives detection signals from a temperature sensor 180A for detecting a temperature of the optical head 16, a start position sensor 180B for detecting a recording start position of the optical head 16, and a terminal position sensor 180C for detecting a terminal position of the optical head 16. The CPU 180 causes the print processing section 183 to control shutter speeds of the shutters of the optical head 16 in accordance with the detection signal from the temperature sensor 180A. Further, the CPU 180 causes the print processing section 183 to control a stepping motor 162a in accordance with the detection signal from the start position sensor 180B and the terminal position sensor 180C.

Here, there will be explained controls of the CPU 180 for the respective sections when the printer 1 receives image data from the exterior after the power source switch 11 is turned on.

When the printer 1 receives image data from the exterior through the infrared communication, the image processing section 182 having an I/F 1821 outputs a signal to the CPU 180 when the receiving section 15 receives the infrared. Upon receipt of this signal, the CPU 180 causes the image processing section 182 to erase image data of both the RAM 184 and the FLASH memory 185. Further, the CPU 180 causes the image processing section 182 to receive new image data, and causes the RAM 184 to store the received new image data via a bus. The CPU 180, the image processing section 182 and the RAM 184 correspond to the receiving section referred to in the present invention.

After the CPU 180 causes the receiving section to receive the image data from the exterior, the CPU 180 causes the image data stored in the RAM 184 to be read out to the image processing section 182, so that the image processing section 182 creates print data. The print data indicates data, which is subjected to a suitable processing in the image processing section 182, so that the data can control shutter speeds of the shutters of the optical head 16, but be different from the image data received by the receiving section. In the following explanation, in order to distinguish the print data from the image data received by the receiving section and stored in the RAM 184, the image data received by the receiving section and stored in the RAM 184 is referred to as a pre-print data.

After the CPU 180 causes the image processing section 182 to create the print data, the CPU 180 causes the image processing section 182 to transfer the print data, so that the print processing section 183 controls shutter speeds of shutters of the optical head 16. Thus, the aperture times of the shutters arranged in the main scanning direction, that is, the shutter speeds, are controlled in accordance with the print data, so that light quantities for three colors of R, G and B passing through the shutters are controlled, respectively. Further, the CPU 180 causes the print processing section 183 to control the stepping motor driver 1621a so that the stepping motor 162a scans the optical head 16 in the sub-scanning direction. Furthermore, the CPU 180 causes the print processing section 183 to control the shutter speeds of the shutters in accordance with the print data for each scanning, so that the light quantity of each light spot in the sub-scanning direction is controlled. In this manner, quantities of the whole light spots are controlled, so that a latent image representative of an image consisting of assemblies of the light spots is recorded on the instant film.

After the CPU 180 causes the optical head 16 to record the latent image on the instant film, the CPU 180 turns off the power source section 181 and causes the development motor driver 17a to drive the development motor 17.

The development motor 17 rotates the development roller so that while the instant film is rolled up and the developer is developed over the instant film, the latent image is developed and the instant film is delivered to exterior of the printer 1. The CPU 180, the print processing section 183, the optical head 16, the stepping motor 162a, the stepping motor driver 1621a, the development motor 17, the development roller 17b, and the claw correspond to the printing section referred to in the present invention.

The above-mentioned description is concerned with the processing which the CPU 180 causes the respective sections to perform when the printer 1 receives on a radio basis image data through the infrared communication or the USB communication after the power source is turned on by the power source switch 11.

Next, there will be explained processing which the CPU 180 causes the respective sections to perform when the print switch 12 is operated.

When the print switch 12 is operated, the CPU 180 causes the image processing section 182 to read out the image data stored in the RAM 184. The CPU 180 corresponds to the image output instruction obtaining section. The CPU 180 causes the image processing section 182 to create print data in accordance with the image data thus read and transfer the print data to the print processing section 183. The print processing section 183 controls the shutters of the optical head 16 in accordance with the print data to control a quantity of light to be projected on the instant film. Control of the light quantity of the respective light spot may project the light quantity according to the image data on the instant film, so that a latent image is recorded in accordance with the image data.

The CPU 180 detects, by change of the detection signal of the terminal position sensor 180C, the fact that the recording of the latent image is completed, and issues an instruction of turning off of the power source section 181 to the power source section 181 and also issues an instruction of driving of the development motor 17 to the development motor driver 17a.

The development motor 17 drives a claw (not illustrated) for sending out the instant film to a development roller side to send out the instant film to the development roller side, so that the development roller rolls up the instant film to be delivered out of the printer 1. Rolling up of the instant film by the development roller makes it possible to develop the developer filled up in the instant film onto the instant film in its entirety and develop the latent image.

Thus, when the print switch 12 is operated, an image is recorded on the instant film in accordance with image data stored in the RAM 184.

It will happen that the print switch SW 12 is operated after the power source turns off. Thus, according to the printer of the present embodiment, there is provided a non-volatile storage “FLASHMEMORY” 185 so that processing for saving of image data and return can be performed.

Thus, the non-volatile storage “FLASHMEMORY” 185 is used to cause the image processing section 182 to perform a transfer of the image data of the RAM 184 to the non-volatile storage so as to save image data of the RAM 184, when the power source turns off by the power source switch SW 11, or when an automatic power off function of the printer of the present embodiment is effective.

When the power source switch SW 11 turns on again, the image processing section 182 transfers image data stored in the non-volatile storage “FLASHMEMORY” 185 so that the image data stored in the non-volatile storage “FLASHMEMORY” 185 is returned to the RAM 184.

In the event that after an image recording is carried out once, too much time passes, image data would become too old. In this situation, if a user erroneously operates the print switch SW 12, it is expected that unnecessary image is inadvertently recorded. This causes the instant film sheet to be wasted. Thus, the CPU 180 prohibits the print processing section 183 from performing the recording processing after the elapse of a predetermined time.

As processing of the prohibition of re-recording, according the present embodiment, the image data of both the RAM 184 and the non-volatile storage “FLASHMEMORY” 185 are retained, and it is informed the user that there is no image to be recorded through a display. Incidentally, since a timer of the CPU 180 counts a predetermined time, it is acceptable that the CPU 180 or the image processing section 182 is used to erase image data of the volatile storage and the non-volatile storage in accordance with the predetermined time counted by the timer, so that the empty of the image is displayed on the LCD panel.

Hereinafter, there will be explained processing for save, return, and erase of image data, and cancel of operation of the print switch SW 12, referring to the following flowcharts.

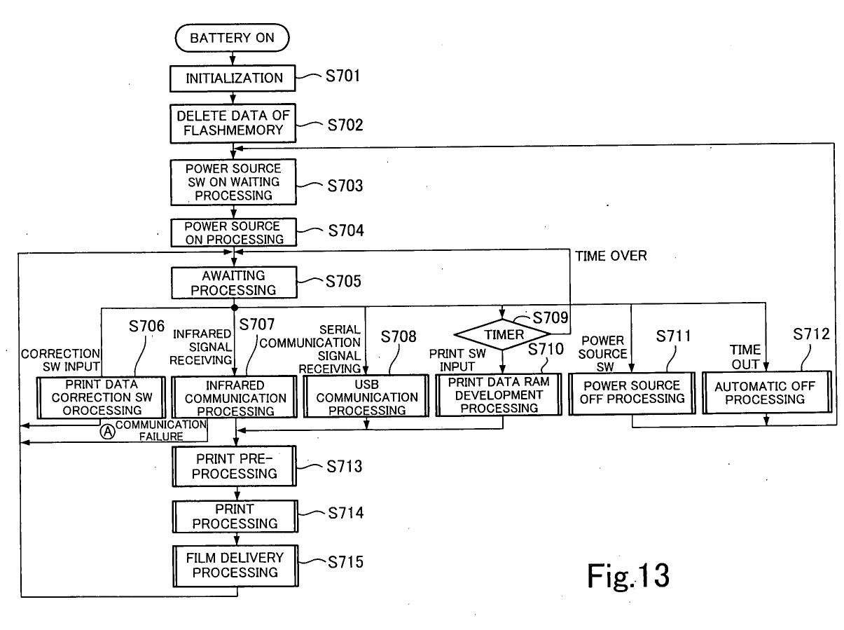

FIG. 13 is a flowchart useful for understanding a processing procedure by the CPU of FIG. 12.

FIG. 13 shows a main process.

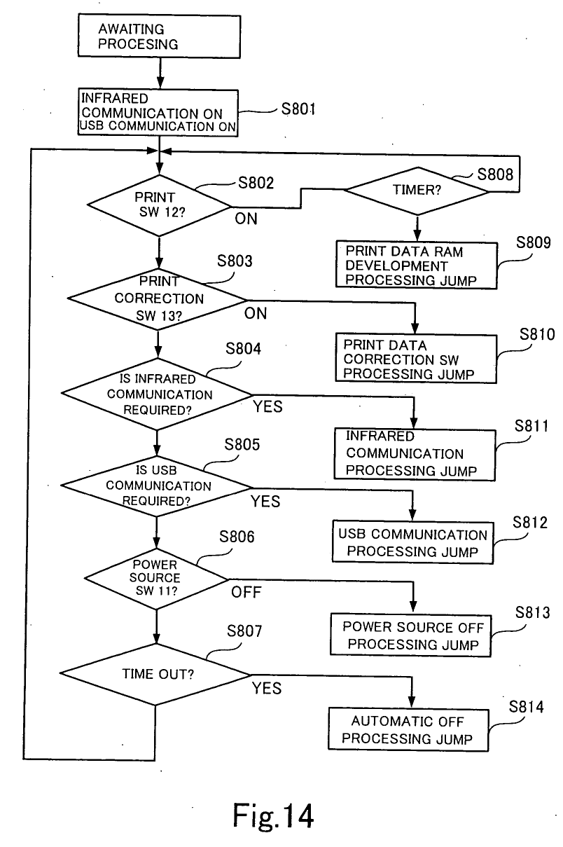

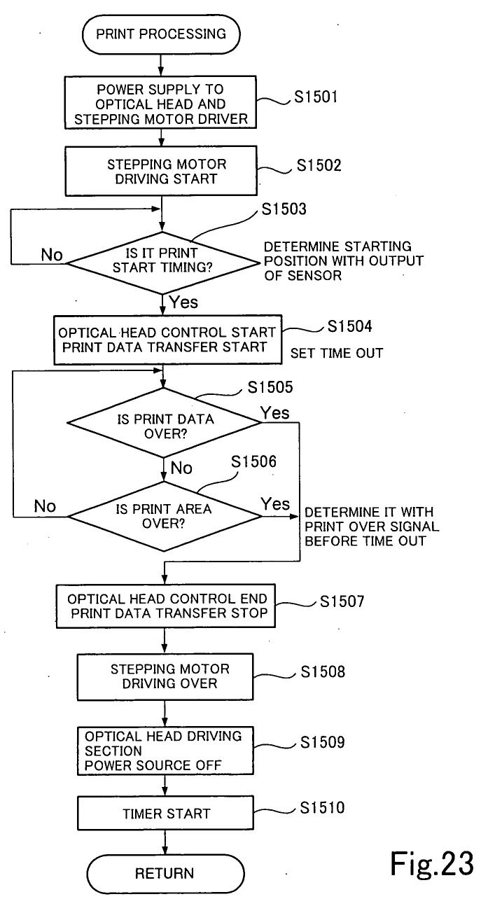

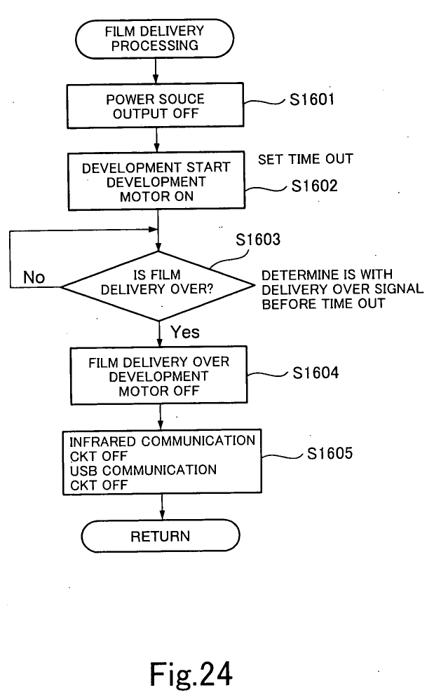

FIG. 14 to FIG. 20, FIG. 23 and FIG. 24 show details of the respective steps of the main process.

First, there will be explained processing of the main routine to be executed by the CPU 180 referring to FIG. 13.

When a battery 1b turns on, first, in step S701, an initialization is carried out. This initialization makes it possible to set up an oscillation frequency of a clock to be supplied to the CPU 180. The CPU 180 has a dissipation power saving mode. In the dissipation power saving mode, there is provided a low frequency of clock. In step S702, image data stored in the non-volatile storage “FLASHMEMORY” 185 is deleted. Here, in order to remove, for example, image data for inspection before forwarding, from the non-volatile storage “FLASHMEMORY” 185, the CPU 180 causes the image processing section 182 to erase the image data.

In step S703, when the power source switch SW 11 turns on, a power turn-on processing is carried out in step S704. In the power turn-on processing, a menu is displayed on a LCD panel, and a clock frequency is increase to enhance the processing speed of the CPU 180.

In step S705, there is carried out an awaiting processing in which it is awaited that a state of a signal to be fed to the CPU 180 is changed over.

Here, as items in which the CPU 180 monitors transition of a state of a signal to be fed to the CPU 180, there are raised such matters that the print switch SW 12, or the print data correction switch SW 13 is operated to turn on, the external I/F 1821 receives image data to detect a receiving signal, the power source switch SW 11 turns off, and the automatic power off function of the printer of the present embodiment is effective.

When the CPU 180 determines that any one of the input states of signals is changed over, the CPU 180 causes the respective sections to perform processing for coping with the changed over state.

In step S706, when the print data correction switch SW 13 is operated to turn on, a print data correction switch processing process of the image processing section 182 is activated to set up on image data a correction factor for the image data according to the operation content of the print data correction switch SW 13, and return to the awaiting state.

When the external I/F 1821 detects the reception of image data from a portable telephone, in step S707, the infrared communication process of the image processing section 182 is activated so that the image obtaining section, which comprises the external I/F 1821 of the image processing section 182 and the RAM 184, obtains image data. When the image obtaining section obtains the image data, in step S713 to S715, the respective processing is carried out and the instant film is delivered to the exterior. In step S708, also when image data is obtained through the USB communication, the same processing as the step S707 is carried out.

In the event that the print switch SW 12 is operated to turn on, in step S709, a timer value in the CPU 180 is referred to, and if it is time over, the process returns to the step S709 for the awaiting processing. Referring to the timer value, if it is a predetermined time or less, the process goes to step S709 in which a print data RAM development processing is carried out, and image data is returned to the RAM 184, so that recording processing for an image is carried out in accordance with the image data in step S713 to step S715. According to the present embodiment, it is treated as an output operation instruction that the print switch SW 12 is operated to turn on. The CPU 180, which serves as the output instruction obtaining section, receives the output operation instruction to perform the recording processing for images.

In the event that the power source switch SW 11 turns off, or when the automatic power off function of the printer of the present embodiment is effective, a power source turn-off processing process of the CPU 180 is activated. Referring to the timer value of the CPU 180, if it is detected that the timer value is a predetermined time or less, the image processing section 182, which corresponds to the image transmission section, causes the image data stored in the RAM 184 to be transferred, so that the image data is saved to the non-volatile storage “FLASHMEMORY” 185. And thereafter, a power source turn-off processing for the respective section is carried out, and the process returns to the main routine.

According to the present embodiment, it is treated as a turn-off instruction for the power source that the power source switch SW 11 is operated to turn off or the automatic power off function of the printer of the present embodiment is effective. The CPU 180 receives the turn-off instruction for the power source to perform a turn-off processing in accordance with the turn-off instruction.

Next, there will be explained in details the respective processes, which are activated when a transition of any one of the states that are the monitored items of the CPU 180, occurs.

FIG. 14 is a flowchart useful for understanding a procedure for the awaiting processing of the step in FIG. 13.

This flow is repeatedly executed. When any one of the states changes over, the associated process starts.

First, in step S801, the external I/F turns on to perform awaiting whether image data is transmitted through the infrared communication and the USB communication.

In step S802 to step S807, there is performed an awaiting control corresponding to the step S705 to the step S710 of the flowchart in FIG. 13.

In the step S802, a transition of the print switch SW 12 into the turn-on of, which is one of the items to be monitored, is detected. In the step S802, when the operation of the print switch SW 12 is detected, the process goes to step S808 in which the timer value is decided. The timer starts after the delivery of the instant film is completed since the print processing process starts in the step S713 of FIG. 13. When the timer value is over a predetermined time, the process returns to the step S802. In the step S802, when it is detected that the timer value is the predetermined time or less, the process goes to step S809 in which the print data RAM developing processing process starts. As mentioned above, when the print switch SW 12 is operated, the re-recording of an image is performed. And thus in some case, there is a possibility that the operation of the print switch SW 12 is erroneous operation. In view of the foregoing, in step S808, the timer value is detected and then the print data RAM developing processing process starts. The decision step by the timer of the CPU 180 corresponds to a part of the re-recording inhibit section referred to in the present invention. According to the present embodiment, the process is returned to the awaiting state in accordance with the decision result of the timer, so that the image processing section 182 does not perform the developing processing of the RAM 184 to inhibit re-recording. Incidentally, it is acceptable that the process returns to the step S702 of FIG. 13 in accordance with the decision result, so that the process returns to the portion of erasing the image data of the FLASH memory 185 and the RAM 184 and skips to the awaiting state.

In the step S803, when it is detected that the print data correction switch SW 13 turns on, the process jumps to step S810 for the print data correction switch processing process in which the print data correction switch processing process in the image processing section 182 starts. As mentioned above, the print data correction switch SW 13 controls dark or light of an image to be recorded on a recording medium. Accordingly, when the print data correction switch SW 13 is operated, the print data correction switch is activated to cause the image processing section 182 to set up a correction factor for correcting image data.

In step S804, when the CPU 180 detects a requirement of the infrared communication in accordance with the detection signal from the external I/F 1821, the process goes to a step S811 for an infrared communication processing process in which the infrared communication processing process is activated. For example, when image data is transmitted from a portable telephone to the receiving section 15 of the printer 1 through infrared, the image data is supplied via the receiving section 15 to the external I/F 1821 of the image processing section 182, so that the external I/F 1821 generates a detection signal indicative of acknowledgement. The detection signal is used to activate the infrared communication processing process as an infrared communication request.

Also in step S805, in a similar fashion to the step S804, the external I/F 1821 receives the fact that image data is transmitted through the USB communication. The image processing section 182 having the external I/F 1821 generates a signal indicative of acknowledgement. This signal is used to activate the USB communication processing process so that the external I/F 1821 of the image processing section 182 receives the image data.

In the step S804 and the step S805, when the image data is obtained, an image recording section records a latent image on the instant film without an operation of the print switch SW 12, and the development roller 17b develops the instant film and delivers the developed instant film to out of the printer 1.

In step S806, when the power source switch SW 11 turns off, the power source OFF processing process of the CPU 180 is activated in step S813.

In step S807, when the timer detects the time out and the automatic power off function works, the automatic off processing process is activated.

In this manner, when any one of the input states changes over, any one of the processes is activated.

Hereinafter, there will be explained details of processing of the step S809 to the step S814.

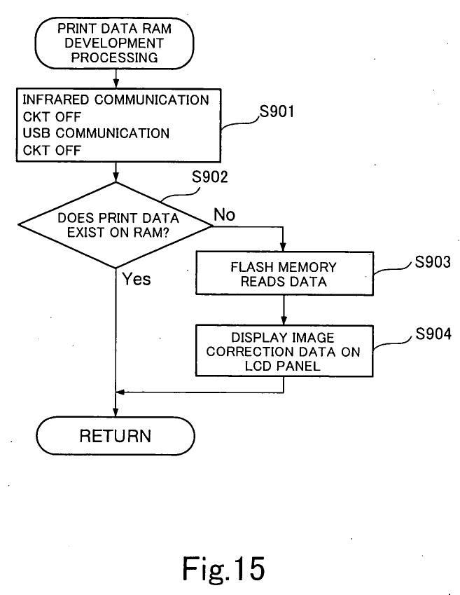

FIG. 15 is a flowchart useful for understanding a procedure for the print data RAM development processing process shown in the step S809 of FIG. 14.

When the print switch SW 12 is operated and the timer value is a predetermined time or less, in step S901, the power source of the external I/F 1821 having a transmission and receiving section for the infrared communication and the USB communication is turned off to refuse to enter new image data.

In step S902, the image processing section 182 determines whether the print data exists on the RAM 184. If it is decided that the print data exists on the RAM 184, the process returns to the main routine in which the recording processing is performed. In the step S902, if it is decided that no print data exists on the RAM 184, the process goes to step S903 in which the image processing section 182 performs a transfer of image data from the FLASH memory 185 to the RAM 184. This image data includes contents of the operation of the print data correction switch SW 13. Accordingly, in step S904, the CPU 180 receives contents of the operation of the print data correction switch SW 13 from among the image data, so that the information is displayed on the LCD panel 14. Thereafter, the process returns to the main routine in which the recording processing is performed.

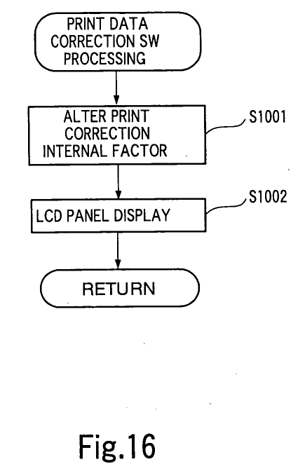

FIG. 16 is a flowchart useful for understanding a processing procedure for the print data correction SW processing process shown in the step S810 of FIG. 14.

The processing of the step S810 is carried out in the image processing process of the image processing section 182.

When the CPU 180 detects the fact that the print data correction switch SW 13 turns on, the CPU 180 causes the image processing section 182 to set up an internal factor for correction of the print data. The print data correction switch SW 13 is usually in the normal state. The print data correction switch SW 13 performs a toggle operation in such a manner that once depression of the switch SW 13 offers a dark (tone), once more depression of the switch SW 13 offers a light (tone), and further once more depression of the switch SW 13 returns to the normal state. Thus, the CPU 180 reads operational contents of the toggle operation to transmit the contents to the image processing section 182. In step S1001, the CPU 180 alters the internal factor to set up the same to the image data. In step S1002, operational contents (for example, N-D-L) of the print data correction switch SW 13 are displayed on the LCD panel 14. When the processing of this process is completed, the process returns to the main process.

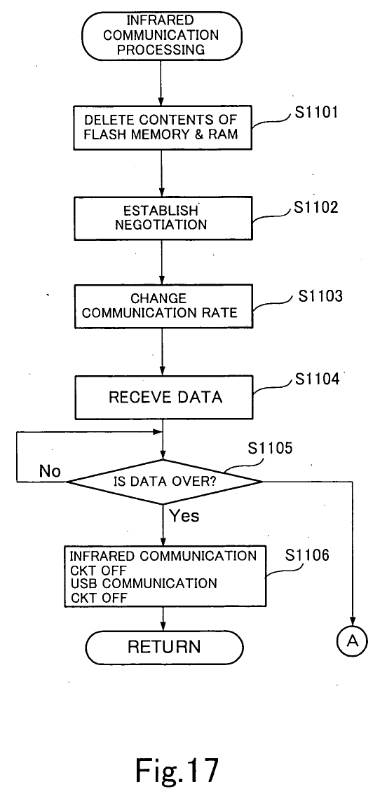

FIG. 17 is a flowchart useful for understanding a processing procedure for the infrared communication processing process shown in the step S811 of FIG. 14.

In the event that the external I/F 1821 receives the infrared communication request, there is no need of old image data. Thus, in step S1101, if the FLASH memory 185 and the RAM 184 store old image data, the image processing section 182 causes the FLASH memory 185 and the RAM 184 to erase the old image data. In other words, when the image data obtaining section initiates obtaining the new image data from the exterior, the CPU 180 and the image processing section 182 cause the FLASH memory 185 and the RAM 184 to erase both the old image data stored therein.

In step S1102, when a communication between the portable telephone and the print switch SW 12 is performed, the external I/F 1821 performs information exchange with the portable telephone and negotiates communication conditions such as a communication rate with the portable telephone so that the infrared communication can be performed. When this negotiation is established, it is decided that the negotiation is approved, and the process goes to step S1103 in which the external I/F 1821 alters a communication rate. In step S1104, the image processing section 182 receives image data so as to be stored in the RAM 184.

In step S1105, it is decided whether image data is completely stored in the RAM 184. And if it is not, the process returns to the step S1104 in which the image data is completely received through the external I/F 1821. When the image data is completely stored in the RAM 184, the process goes to step S1106 in which of the output of the power source section 181 a power supply to the external I/F 1821 is turned off. And thereafter, the process returns to the main process. In the step S1105, when it is outputted to the CPU 180 side that the process of the image processing section 182 is failure in receiving of image data, the CPU 180 immediately terminates this process, and the process returns to the main process.

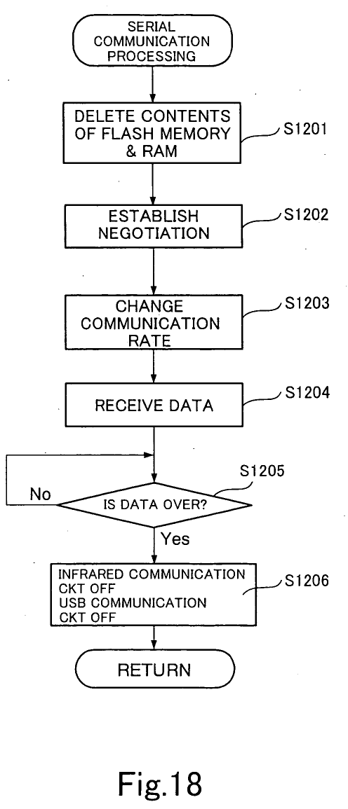

FIG. 18 is a flowchart useful for understanding a UBS communication processing process shown in the step S812 of FIG. 14.

When image data is transmitted through the UBS communication, the processing is carried out in accordance with this flowchart. In this case, it is the same as the processing of the infrared communication.

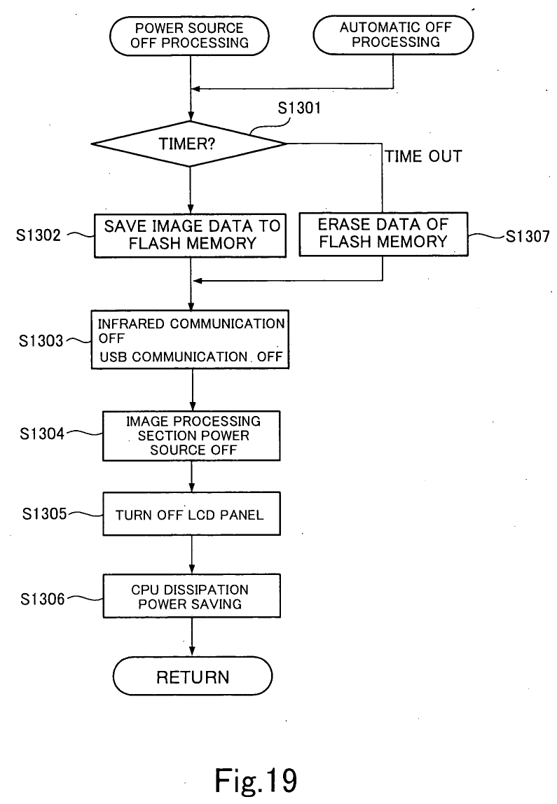

FIG. 19 is a flowchart useful for understanding a processing procedure for the print data power source off processing process and the automatic off processing process shown in the steps S813 and S814 of FIG. 14.

This process is also carried out by the image transmission section comprising the CPU 180 and the image processing section 182.

First, in step S1301, a timer value of a timer, which is activated when the previous image recording is performed, is referred to. If it is time out, image data of the RAM 184 is not saved to the FLASH memory 185, and the process goes to step S1307 in which the image data of the FLASH memory 185 is erased, and the process goes to step S1303. In step S1301, if the timer value is a predetermined value or less, the process goes to step S1302 in which the image processing section 182 performs a transfer of image data to the FLASH memory 185 to save image data. Thus, when the power source switch SW 11 is turned on again within a predetermined time, it is possible to perform a re-recording for an image. Further, it is possible to erase old image data at the time of processing for the turn-off of the power source.

Here, it is desired that a capacity of the FLASH memory 185 is established as smaller as possible, and thus data before print is saved to the FLASH memory 185. However, in the event that the FLASH memory 185 is provided with a large capacity, it is acceptable that print data after the image processing is saved to the FLASH memory 185. Saving the print data after the image processing makes it possible to omit the print pre-processing process of the step S709, after the image data to be returned to the RAM 184 is transferred from the FLASH memory 185 to the RAM 184, and thereby promptly start the print processing process.

In step S1304, the power source section 181 stops a power supply to the external I/F 1821 of the image processing section 182 to stop the infrared communication function and the USB communication function. In step S1304, the power source section 181 stops a power supply to the image processing section 182 too.

In step S1305, the LCD panel is turned off. In step S1306, the CPU 180 is set up to be operative in the dissipation power saving mode, and the process returns to the main routine.

Of those awaiting processing processes, the infrared communication processing process and the RAM development processing process are activated and then the processing of the step S713 to the step S715 of the flowchart of FIG. 13 is carried out. Accordingly, hereinafter, there will be explained details of processing processes of the step S713 to the step S715 of the flowchart of FIG. 13.

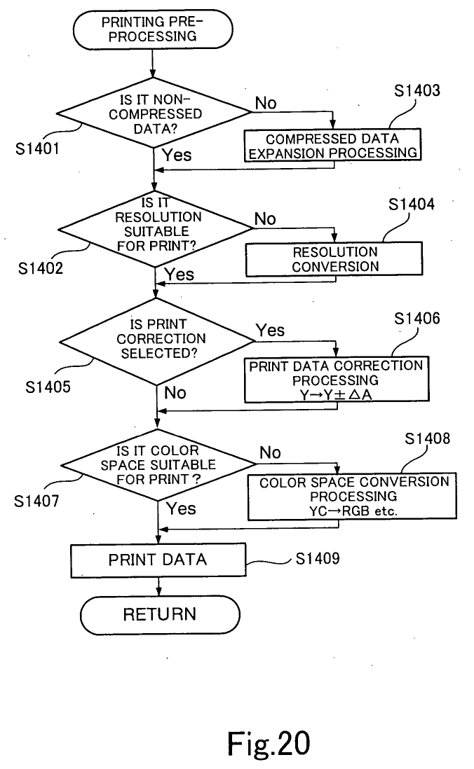

FIG. 20 is a flowchart useful for understanding a processing procedure for the printing pre-processing process shown in the step S713 of FIG. 13. FIG. 23 is a flowchart useful for understanding a processing procedure for the printing processing process shown in the step S714 of FIG. 13. FIG. 24 is a flowchart useful for understanding a processing procedure for the film delivery process shown in the step S715 of FIG. 13.

First, the printing pre-processing process, which is carried out by the image processing section 182, will be explained referring to FIG. 20.

In step S1401, it is determined whether the received data is non-compression data. When it is decided that the received data is non-compressed data, there is no need of the expansion of the image data and thus the process goes to step S1402. When it is decided that the received data is compressed data, the process goes to step S1403 in which the image processing section 182 performs the expansion processing for the compressed data. In the step S1402, it is determined whether a resolution is suitable for the printer 1 in printing. In the event that it is decided that the resolution is suitable for the printer 1 (for example, in case of VGA), the process goes to step S1405. In the event that it is decided that the resolution is not suitable for the printer 1 (for example, in case of ishot L, or 1 mega), the process goes to step S1404 in which the image processing section 182 performs a conversion of the resolution. At that time, there is performed a processing for arranging a meeting between an image plane size, which will be described later and a print size. In case of the ishot L size, there is carried out an expansion processing of 1.4 to 1.8 times. In case of the 1 mega size, there is carried out thinning processing or reduction processing. As mentioned above, in order to reduce the time required for the communication, according to the present embodiment, the ishot L is set up as the initial data. Thus, the image data is obtained soon, the resolution is varied, and an image is printed. An expansion on the order of 1.4 to 1.8 times or so does not particularly deteriorate the image quality, and does not need a much time required for a communication. Thus, it is possible to perform a printing of an image promptly. The image processing section 182 corresponds to the pixel number conversion section referred to in the present invention.

In step S1405, it is determined whether the print data correction switch SW 13 is not operated. In the event that the print data correction switch SW 13 is not operated, the process goes to step S1407. In the event that the print data correction switch SW 13 is operated, so that image data is corrected, the process goes to step S1406 in which the print data correction processing is carried out. The step S1406 shows an example of the conversion wherein an offset adjustment (±A) is applied to luminance data Y.

In the step S1407, it is determined whether the color space is suitable for a recording of an image. When it is decided that the color space is not suitable for a recording of an image, the process goes to step S1408 in which a display image signal (YC signal) comprising luminance data Y and chroma data C is converted into RGB signal. In step S1409, print data is generated from the RGB signal.

When the image processing section 182 creates the print data, the print data is transferred to the print processing section 183, so that the print processing section 183 performs the recording processing for the image.

Here, there will be explained an outline of a processing for a resolution conversion of the image processing section 182 that is the pixel number conversion section.

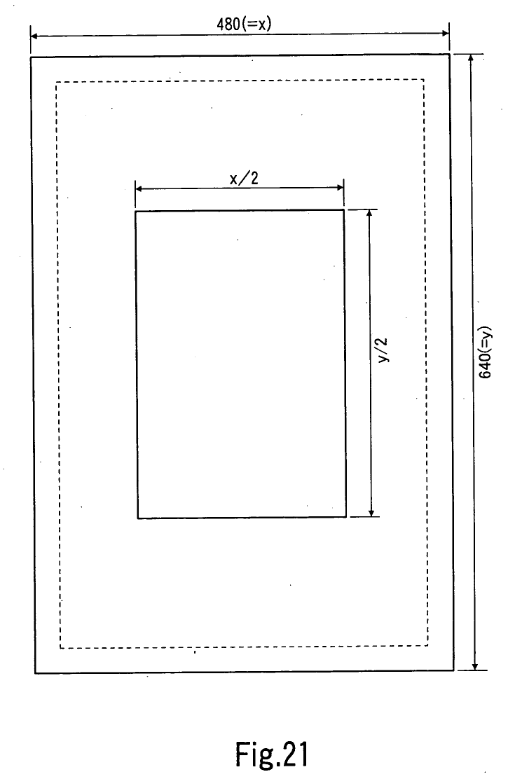

FIG. 21 is a view showing a difference between the size of the image plane of the portable telephone and the print size of the printer.

As mentioned above, the print size is determined in accordance with the VGA size, while the size of the image plane is concerned with three types of sizes of ishot L size, VGA size, and 1 MEGA size.

A frame shown in FIG. 21 denotes the VGA size in which 480×640 of number of pixels are included. It is assumed that the number of pixels 480 in a horizontal direction is denoted by “x” and the number of pixels 640 in a vertical direction is denoted by “y”. Thus, as depicted with a frame of the solid line at the center of FIG. 21, the number of pixels of the image plane size of the ishot L, which is initialized at the portable telephone side is expressed by x/2:y/2. This image plane size is addresses as a QVGA. In the QVGA, as compared with the VGA, the number of pixels is 0.5 times with respect to length and breadth of an image. In this manner, a preparation of the number of pixels of 0.5 times in length and breadth makes it possible to perform an expansion processing for an image to a level in such an extend that roughness of a printed image is not conspicuous, ensuring the higher communication rate than the transmission speed of the number of pixels of the VGA. The portion depicted by the dotted line is an area in which an expanded image is printed.

According to the present embodiment, the image data is converted into image data of any one of magnifications in which the number of pixels of length and breadth of an image is more than 1.4 times and less than 1.8 times.

For example, when data of image plane size of ishot S (120×120) is transmitted, the number of pixels is less than ½ of the VGA size that is the print size, so that there is given such an impression that an image is printed out on for example only the center of the print surface. When the image data less than ½ of the VGA size is subjected to the expansion processing with magnification of 1.8 times or more, the printed out image would be conspicuous in roughness. In view of the foregoing, according to the photographic printing system of the present embodiment, the selection of the image plane size is inhibited.

Thus, according to the present embodiment, the image data is converted into image data in which the number of pixels of length and breadth of an image is more than 1.4 times and less than 1.8 times. This feature makes it possible to print-out a high quality of image not much roughness.

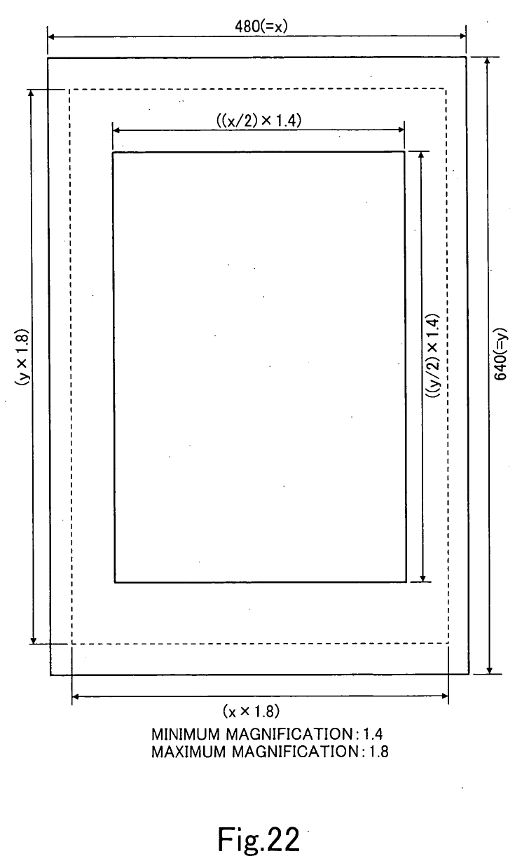

FIG. 22 is another view showing areas of a print surface.

As shown in FIG. 22, an area, in which ishot L size is expanded to 1.4 times to 1.8 times, is an area in which image quality is ensured.

In a case where the minimum magnification is 1.4, sizes of length and breadth of an image are expressed by (x/2×1.4)×(y/2×1.4) taking VGA size x×y as a standard. While the outside of the area of this size is a margin, it is possible to obtain a clear photograph in which an image excellent in image quality is suitably expanded on the print surface at the center and is printed.

In a case where the maximum magnification is 1.8, an image is substantially fully expanded to the print surface and is printed within the area depicted by the dotted line, so that there is obtained a photograph in which the photograph of the minimum magnification is little expanded. Anyway, it is possible to print out a high quality of image not much roughness.

In case of the VGA size, a printing is performed fully on the print surface, and if it is concerned with 1 mega size, the pixel data is thinned and the printing is performed to meet the VGA size. In this case, it is not expanded, and thus it is possible to print out a high quality of image.

FIG. 23 is a flowchart useful for understanding a processing procedure for the printing processing process, as shown in the step of FIG. 13, of the print processing section 183.

First, in step S1501, the print processing section 183 performs a power supply to the stepping motor driver 1621a and the optical head 16. In step S1502, the print processing section 183 causes the stepping motor 162a to start a driving. In step S1503, it is determined whether it is a printing start timing. The printing start timing indicates a timing of transmission of data from the print processing section 183 to the shutters. Here, it is determined whether the position of the optical head 16 is at the side of the start position sensor 180B. In the step S1503, when it is decided that the position of the optical head 16 is at the side of the start position sensor 180B, the process goes to step S1504 in which the transmission of the print data is initiated so that the print processing section 183 starts the control of the shutter speed of the shutter section of the optical head 16. The print processing section 183 controls the shutter speed of the shutter section of the optical head 16 in accordance with the transferred print data so that the optical head 16 records 480 dots of light spots. After the optical head 16 records 480 dots of light spots in the main scanning direction, the stepping motor 162a is driven, so that the optical head 16 is moved by the corresponding one line to record a line of light spots in the subsequent main scanning line. In this manner, the stepping motor 162a drives the optical head 16 to shift one by one on a line basis so that light spots are sequentially recorded.

In step S 1505, it is determined whether the print data is over. When it is decided that the print data to be transferred is absent in the print processing section 183, the process goes to step S1507. When the it is decided that the print data to be transferred is present in the print processing section 183, the process goes to step S1506 in which it is determined whether the print area is over. In the step S1506, when the output of the terminal position sensor 180C, which indicates the print area over of the image, is not varied, the process returns to the step S1505.

In the step S1506, when it is decided that the position of the optical head 16 is at the print area over portion through the change over of the output of the terminal position sensor 180C, the process goes to the step S1507.

In the step S1507, the control of the optical head 16 by the print processing section 183 is terminated, and the transfer of the print data is stopped. In step S1508, the print processing section 183 causes the stepping motor 162a to stop in driving. In step S1509, the power supply to the optical head 16 is stopped. In step S1510, the print processing section 183 causes the timer to start a time up to the next image recording. Thus, there is counted a time after the present image recording up to the next image recording. The time counting result is a criterion as to whether the image processing section 182, which corresponds to the image transmission section and the image data erasing section, performs a transmission of the image data, or performs an erasing of the image data.

After this flow is terminated, the delivery processing of the instant film is started.

FIG. 24 is a flowchart useful for understanding a processing procedure for the instant film delivery processing process shown in the step of FIG. 13.

First, in step S1601, the power source section 181 turns off. In step S1602, the development motor 17 is driven to rotate the development roller 17b. In step S1603, it is determined whether the instant film delivery processing process is over. When delivery of the instant film is detected, the driving of the development motor 17 is stopped. In order to detect the completion of the delivery of the instant film, a sensor is used to detect that the instant film is absent inside the printer 1 before the time out required for the usual delivery processing.

In the step S1603, when it is detected that the delivery of the instant film is completed, the process goes to step S1604 in which the development motor 17 is turned off. In step S1605, a supply of electric power to the external I/F 1821 having the infrared communication function and the USB communication function is stopped.

The above-mentioned description is concerned with the process related to recording of an image of image data.

Thus, such a simple operation that image data is transmitted from the portable telephone makes it possible to perform a printing.

Hitherto, it is obliged that after complicated operations are applied at the portable telephone side, a transmission of image data is performed. To the contrarily, according to the photographic printing system of the present embodiment, a portable telephone down loads onto a printer a photographic printing processing program, and the photographic printing processing program is started. This feature makes it possible to simply perform an image recording using the infrared communication.

Further, according to the photographic printing system of the present embodiment, in the event that the photographic printing processing program is started to perform photography, as the initial data, the ishot L data is set up. Thus, the direct transmission of the image data makes it possible to reduce the communication time, and thereby performing a recording of a high quality of image to meet the print size of the printer side. Further, in the event that it is desired to change the print size, an alteration of setting of the image plane size at the portable telephone side makes it possible to perform the recording of a high quality of image, even if any one of VGA size and 1 mega size is concerned.

According to the present embodiment, as the recording medium, there is raised the instant film by way of example, so that a printer records an image on the instant film. However, it is acceptable that as the recording medium, a usual paper is used to perform a recording on the usual paper.

As mentioned above, according to the present invention, it is possible to provide a photographic printing system in which the number of pixels of image data to be treated in an image taking apparatus is initialized to a suitable number of pixels.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A photographic printing system comprising: an image taking apparatus having an image taking section for obtaining image data through taking a photography, and a transmission section for transmitting the image data obtained by the image taking section; and a printer having a receiving section for receiving the image data transmitted from the image taking apparatus, and a printing section for printing out an image of a predetermined number of pixels in accordance with the image data received by the receiving section,
wherein the image taking apparatus is initialized in such a manner that a number of pixels of image data to be treated by the image taking apparatus is less than a number of pixels of an image to be printed out by the printing section of the printer, and
wherein the printer has a pixel number conversion section for converting the image data received by the receiving section to image data of the number of pixels suitable for printing out in the printing section.

2. A photographic printing system according to claim 1, wherein the image taking apparatus has a pixel number setting section for setting over again a number of pixels of the image data to be treated by the image taking apparatus from among a plurality of number of pixels including the initialized number of pixels in accordance with operation.

3. A photographic printing system according to claim 1, wherein the number of pixels to be initialized in the image taking apparatus is not less than 0.5 times and less than 1.0 times with respect to length and breadth of an image as compared with the number of pixels of an image to be printed out by the printing section of the printer.

4. A photographic printing system according to claim 1, wherein when the pixel number conversion section receives image data of the number of pixels initialized in the image taking apparatus, the pixel number conversion section converts the image data into image data of a number of pixels of any one of magnifications in which the number of pixels is not less than 1.4 times and not above than 1.8 times with respect to length and breadth of an image.

5. A photographic printing system according to claim 1, wherein the transmission section and the receiving section transmits and receives image data through an infrared communication, respectively.

6. A photographic printing system according to claim 1, wherein the image taking apparatus is incorporated into a portable type of telephone.
